(19) United States
(12) Patent Application Publication
(10) Pub. No.: US 2025/0267330 A1
(43) Pub. Date: Aug. 21, 2025

(54) ELECTRONIC DEVICE FOR DISPLAYING VIRTUAL OBJECT, AND CONTROL METHOD THEREFOR

(71) Applicant: Samsung Electronics Co., Ltd., Suwon-si (KR)

(72) Inventors: Sooyoung NAM, Suwon-si (KR); Sunmin HWANG, Suwon-si (KR); Yongsuk KWON, Suwon-si (KR); Youngjun SEO, Suwon-si (KR); Munhwan CHOI, Suwon-si (KR)

(21) Appl. No.: 19/194,937

(22) Filed: Apr. 30, 2025

Related U.S. Application Data
(63) Continuation of application No. PCT/KR2023/018068, filed on Nov. 10, 2023.

(30) Foreign Application Priority Data
Nov. 11, 2022 (KR) 10-2022-0150293
Dec. 7, 2022 (KR) 10-2022-0169842

(51) Int. Cl. H04N 21/431; G06F 3/0486; H04N 21/4223; H04N 21/472; H04N 21/81

(52) U.S. Cl. CPC H04N 21/4314; G06F 3/0486; H04N 21/4223; H04N 21/47205; H04N 21/8153

(57) ABSTRACT

An electronic device is provided. The electronic device includes a communication module, a camera module, a display module, memory, comprising one or more storage media, storing instructions, and at least one processor communicatively coupled to the communication module, the camera module, the memory, and the display module, wherein the instructions, when executed by the at least one processor individually or collectively, cause the processor to establish communication with an external electronic device through the communication module, display a first image and a first object through the display module based on information obtained from the external electronic device, change, based on a user input, information associated with the first object, transmit, to the external electronic device, the changed information associated with the first object, obtain, from the external electronic device, information associated with the first object changed by the external electronic device, and display, based on the information changed by the external electronic device, the first object through the display module.

### CROSS-REFERENCE TO RELATED APPLICATION(S)

This application is a continuation application, claiming priority under 35 U.S.C. § 365 (c), of an International application No. PCT/KR2023/018068, filed on Nov. 10, 2023, which is based on and claims the benefit of a Korean patent application number 10-2022-0150293, filed on Nov. 11, 2022, in the Korean Intellectual Property Office, and of a Korean patent application number 10-2022-0169842, filed on Dec. 7, 2022, in the Korean Intellectual Property Office, the disclosure of each of which is incorporated by reference herein in its entirety.

### BACKGROUND

### 1. Field

The disclosure relates to an electronic device for displaying a virtual object and a method of controlling the same.

### 2. Description of Related Art

Recently, electronic devices are being developed in various forms for convenience of users, and provide various services or functions. Information according to execution of various services or functions of electronic devices provides various services by using augmented reality technology.

Augmented reality (AR) is one field of the virtual reality and refers to a computer graphic scheme that synthesizes a real environment and a virtual object or information and makes the object looked as an object existing in the original environment. Augmented reality corresponds to a technology that shows a virtual object overlaid on the real world viewed through the user's eyes, and is also called mixed reality (MR) because additional information and a virtual world are added to the real world, and only one image is shown in real time.

As smartphones have become widespread recently, the augmented reality technology can be applied to various real environments, and its scope of utilization is variously expanding to location-based services, mobile games, education fields, and the like. The augmented reality technology may provide an anchoring scheme that fixes objects displayed in the augmented reality space.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for displaying a virtual object and a method of controlling the same.

Additional aspects will be set forth in part in the description which follows and, in part, will be apparent from the description, or may be learned by practice of the presented embodiments.

In accordance with an aspect of the disclosure, an electronic device is provided. The electronic device includes a communication module, a camera module, a display module, memory, comprising one or more storage media, storing instructions, and at least one processor communicatively coupled to the communication module, the camera module, the display module, and the memory, wherein the instructions, when executed by the at least one processor individually or collectively, cause the electronic device to establish communication with an external electronic device through the communication module, display a first image and a first object through the display module, based on information obtained from the external electronic device, change information associated with the first object, based on a user input, transmit the changed information associated with the first object to the external electronic device, obtain the information associated with the first object changed by the external electronic device, from the external electronic device, and display the first object through the display module, based on the information changed by the external electronic device.

In accordance with another aspect of the disclosure, a method by an electronic device is provided. The method includes establishing communication with an external electronic device through a communication module, displaying a first image and a first object through a display module, based on information obtained from an external electronic device, changing information associated with the first object, based on a user input, transmitting the changed information associated with the first object to the external electronic device, obtaining information associated with the first object changed by the external electronic device, from the external electronic device, and displaying the first object through the display module, based on the information changed by the external electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include establishing communication with an external electronic device through a communication module, displaying a first image and a first object through a display module, based on information obtained from an external electronic device, changing information associated with the first object, based on a user input, transmitting the changed information associated with the first object to the external electronic device, obtaining information associated with the first object changed by the external electronic device, from the external electronic device, and displaying the first object through the display module, based on the information changed by the external electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a block diagram illustrating an example of a configuration of the electronic device according to an embodiment of the disclosure;

FIG. 3 is a flowchart illustrating a method by which the electronic device displays virtual objects according to an embodiment of the disclosure;

FIGS. 4A, 4B, 4C, 4D, and 4E are diagrams illustrating an example in which the electronic device controls virtual objects obtained from an external electronic device according to various embodiments of the disclosure;

FIG. 5 is a flowchart illustrating an operation in which the electronic device changes object-related information, based on an event for controlling a virtual object being detected according to an embodiment of the disclosure;

FIGS. 6A and 6B are diagrams illustrating an example in which the electronic device changes object-related information, based on an event for controlling a virtual object being detected according to various embodiments of the disclosure;

FIG. 7 is a flowchart illustrating an operation in which the electronic device generates a virtual object and transmits information related to the generated virtual object to the external electronic device according to an embodiment of the disclosure;

FIGS. 8A, 8B, and 8C are diagrams illustrating an example in which the electronic device generates a virtual object and displays the generated virtual object, based on information obtained by the external electronic device according to various embodiments of the disclosure;

FIG. 9 is a flowchart illustrating an operation in which the electronic device changes spatial information of the virtual object generated by the external electronic device according to an embodiment of the disclosure;

FIGS. 10A and 10B are diagrams illustrating an example in which the electronic device changes spatial information of the virtual object generated by the external electronic device according to various embodiments of the disclosure; and

FIG. 11 is a flowchart illustrating an operation in which the electronic device transmits a spatial movement request for the virtual object to a server according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

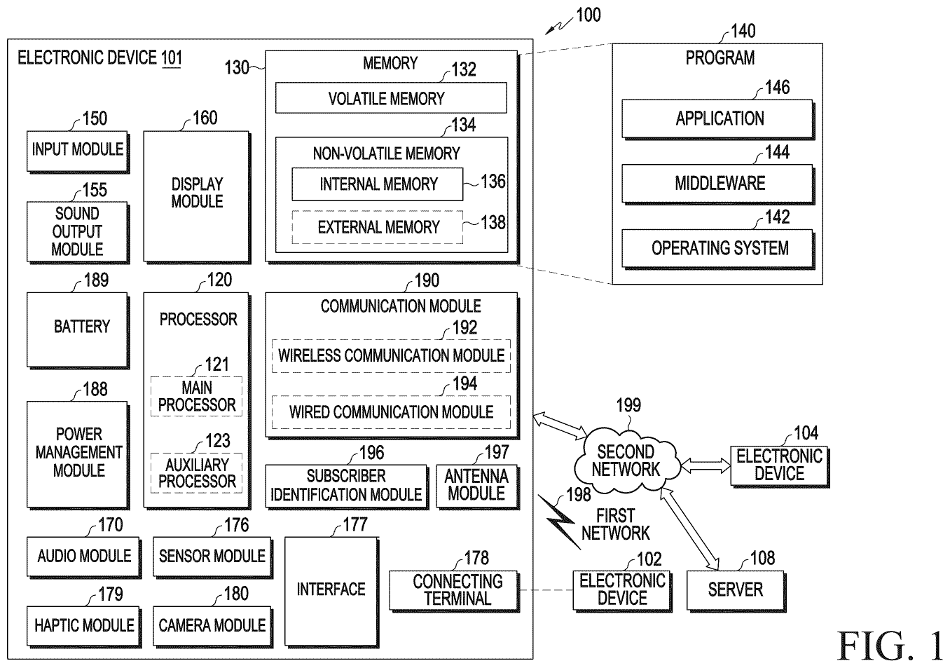

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

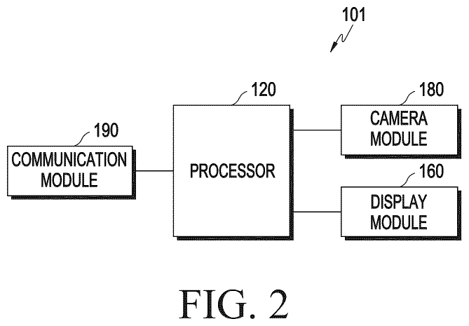

FIG. 2 is a block diagram illustrating an example of a configuration of an electronic device 101 (for example, the electronic device 101 of FIG. 1) according to an embodiment of the disclosure.

Referring to FIG. 2, in an embodiment, the electronic device 101 may include a communication module 190, a camera module 180, a display module 160, and at least one processor 120 operatively connected to the communication module 190, the camera module 180, and the display module 160.

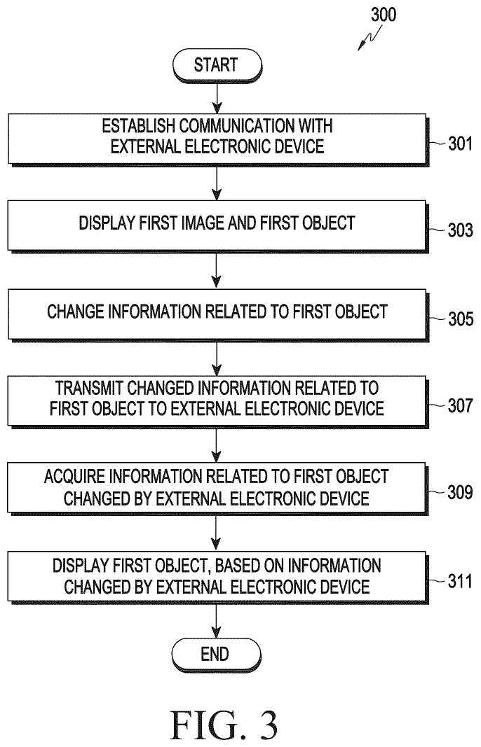

In an embodiment, the communication module 190 may be included in the communication module 190 of FIG. 1. In an embodiment, the communication module 190 may communicate with an external electronic device (for example, the electronic device 102 or the electronic device 104 of FIG. 1) through a first network (for example, the first network 198 of FIG. 1) or a second network (for example, the second network 199 of FIG. 1). In an embodiment, the external electronic device may be an electronic device capable of performing an operation based on an application such as a smartphone, a tablet PC, a laptop, a smart TV, and a desktop. In an embodiment, the electronic device 101 (for example, the communication module 190) may transmit data to the external electronic device and/or receive data from the external electronic device. In an embodiment, the electronic device 101 may transmit and/or receive a voice and/or an image to/from the external electronic device. The electronic device 101 may transmit and receive information associated with a virtual object to and from the external electronic device. Information transmitted and/or received by the electronic device 101, based on communication with the external electronic device is described below with reference to FIGS. 3, 4A to 4E, 5, 6A, 6B, 7, 8A to 8C, 9, 10A, 10B, and 11.

In an embodiment, the camera module 180 may be included in the camera module 180 of FIG. 1. In an embodiment, the camera module 180 may include a plurality of cameras. In an embodiment, the camera module 180 may include a front camera disposed in a direction facing a user's face from the electronic device 101 and at least one rear camera disposed in a direction in which the user faces a subject.

In an embodiment, the display module 160 may be included in the display module 160 of FIG. 1. In an embodiment, the display module 160 may display an image acquired by the camera module 180. For example, the display module 160 may display an image acquired by the front camera or an image acquired by the rear camera. In an embodiment, the display module 160 may display an image acquired from the external electronic device and/or a virtual object through the first network 198 or the second network 199 of FIG. 1. The display module 160 may display a dynamic image (for example, a preview image or a moving image) and/or a still image acquired from the camera module 180 and/or the external electronic device.

In an embodiment, the processor 120 may be included in the processor 120 of FIG. 1. In an embodiment, the processor 120 may perform the overall operation for displaying a virtual object and controlling the displayed virtual object. In an embodiment, the processor 120 may include one or more processors for controlling a virtual object. One or more processors may be operatively connected to the communication module 190, the camera module 180, and the display module 160. The operation performed to control the virtual object by the processor 120 according to an embodiment is described below with reference to FIGS. 3, 4A to 4E, 5, 6A, 6B, 7, 8A to 8C, 9, 10A, 10B, and 11.

Although FIG. 2 illustrates that the electronic device 101 includes the communication module 190, the camera module 180, the display module 160, and/or the processor 120, but is not limited thereto. For example, the electronic device 101 may further include at least one element illustrated in FIG. 2. For example, the electronic device 101 may include a sensor module (for example, the sensor module 176 of FIG. 1) configured to detect a user's gesture. The electronic device 101 may include memory (for example, the memory 130 of FIG. 1) configured to store instructions. The instructions may cause the electronic device 101 to, when executed by the processor 120, perform at least one operation. The detailed operation performed by the electronic device 101 is described below with reference to FIGS. 3, 4A to 4E, 5, 6A, 6B, 7, 8A to 8C, 9, 10A, 10B, and 11. In the disclosure, “the processor performing the operation” may include “the memory causing the electronic device to, when executed by the processor, perform the operation”.

FIG. 3 is a flowchart 300 illustrating a method by which an electronic device (for example, the electronic device 101 of FIG. 2) displays a virtual object according to an embodiment of the disclosure.

In an embodiment, operations illustrated in FIG. 3 are not limited to the illustrated orders, but may be performed in various orders. According to an embodiment, more operations than the operations illustrated in FIG. 3 may be performed, or at least one operation fewer than illustrated may be performed.

Referring to FIG. 3, in operation 301, the electronic device 101 (for example, the processor 120 of FIG. 2) may establish communication with an external electronic device (for example, the electronic device 102 or the electronic device 104 of FIG. 1) in an embodiment.

In an embodiment, the electronic device 101 may establish communication with the external electronic device through a communication module (for example, the communication module 190 of FIG. 2). In an embodiment, the electronic device 101 may make a request for a video call to the external electronic device through the communication module 190. For example, the electronic device 101 may transmit an SIP request message to the external electronic device, based on a session description protocol (SDP) and/or a session initiation protocol (SIP). In an embodiment, the electronic device 101 may make a request for a video conference to the external electronic device through the communication module 190, and an application executed by the electronic device 101 to establish communication with the external electronic device is not limited to the above-described example. The electronic device 101 may obtain, from the external electronic device, acceptance of the video call generated based on the request. For example, the electronic device 101 may obtain, from the external electronic device, an SIP response message generated based on the SIP request message. The electronic device 101 may form a data transmission channel between the electronic device 101 and the external electronic device, based on acquisition of acceptance of the video call from the external electronic device. For example, the electronic device 101 may establish a media session between the electronic device 101 and the external electronic device such as an Internet Protocol (IP) multimedia subsystem (IMS) data channel. In an embodiment, the electronic device 101 may transmit a voice and/or an image to the external electronic device through the data transmission channel. The electronic device 101 may acquire a voice and/or an image from the external electronic device through the data transmission channel. The electronic device may further obtain, from the external electronic device, spatial coordinates of the image obtained from the external electronic device. The spatial coordinates of the image may be three-dimensional spatial information for mapping a virtual object to a reality image. In an embodiment, the electronic device 101 may further obtain (or receive), from the external electronic device, information associated with the virtual object. In an embodiment, the information related to the virtual object may include a location, a rotation angle, and/or attribute information of the virtual object in the reality image. The information related to the virtual object may further include a change record of the location, the rotation angle, and/or the attribute information of the virtual object. The information related to the virtual object is not limited to the above-described example.

In operation 303, the electronic device 101 may display a first image and a first object in an embodiment.

In an embodiment, the electronic device 101 may display the first image and the first object through a display module (for example, the display module 160 of FIG. 2), based on information obtained from the external electronic device. In an embodiment, the information which the electronic device 101 obtained from the external electronic device may include spatial coordinates of the first image and information related to the first object. In an embodiment, when an additional function of virtual information is activated based on a user input, the electronic device 101 may obtain the spatial coordinates of the first image and the information related to the first object from the external electronic device. In an embodiment, the spatial coordinate of the first image and the information related to the first object may be stored in advance by the external electronic device. The spatial coordinates of the first image and the information related to the first object may be stored in advance in a server (for example, the server 108 of FIG. 1). In an embodiment, the electronic device 101 or the external electronic device may model a reality image to a three-dimensional spatial coordinates, based on a camera module and/or LiDAR. In an embodiment, the electronic device 101 or the external electronic device may model a three-dimensional space for mapping the virtual object to the reality image, based on the reality image regardless of whether a data channel stream is formed between the electronic device 101 and the external electronic device. The first image may be a reality image obtained by the external electronic device. The first object may be a virtual object generated by the external electronic device. In an embodiment, the first object may be a virtual object in a shape such as furniture, a picture, or a pet, but there is no limitation. In an embodiment, the information related to the first object may include a location of the first object in the spatial coordinates of the first image, a rotation angle of the first object, and attribute information of the first object. In an embodiment, the electronic device 101 may display the first image obtained from the external electronic device in at least a partial area of the display module 160. The electronic device 101 may display the first object obtained from the external electronic device in at least a partial area of the area in which the first image is displayed. In an embodiment, the electronic device 101 may display the first object in a layer higher than the first image by disposing the first object in a modeled three-dimensional spatial coordinates. The electronic device 101 may display mixed reality obtained by anchoring the virtual object to the reality space by displaying the first image and the first object.

In an embodiment, the electronic device 101 may further display an image obtained by a camera module (for example, the camera module 180 of FIG. 2) in the display module 160. For example, the electronic device 101 may control the display module 160 to display an image obtained by a front camera or an image obtained by a rear camera. The electronic device 101 may transmit the image obtained by the camera module 180 to the external electronic device through the communication module 190. The electronic device 101 may display the first image obtained from the external electronic device and the image obtained by the camera module 180 through the display module 160, so as to share the image with the external electronic device in real time.

In operation 305, in an embodiment, the electronic device 101 may change the information associated with the first object.

In an embodiment, the electronic device 101 may change the information associated with the first object, based on a user input in the state in which communication with the external electronic device is established. In an embodiment, the user input may be a gesture detected based on the image obtained by the camera module 180. For example, the electronic device 101 may detect a gesture of a user's body, based on the image obtained by the front camera or the rear camera. In an embodiment, based on identification that the image obtained by the front camera is shared with the external electronic device, the electronic device 101 may detect a gesture, based on the image obtained by the rear camera. In an embodiment, based on identification that the image obtained by the rear camera is shared with the external electronic device, the electronic device 101 may detect a gesture, based on the image obtained by the front camera. In an embodiment, the electronic device 101 may detect a gesture, based on the image obtained by one of the front camera and the rear camera and transmit the image to the external electronic device. For example, the electronic device 101 may detect a gesture, based on the image obtained by the front camera and transmit the image obtained by the front camera to the external electronic device. The electronic device 101 may detect a gesture, based on the image obtained by the rear camera and transmit the image obtained by the rear camera to the external electronic device.

In an embodiment, the user input may be a touch event for the display module 160. The electronic device 101 may change the information associated with the first object, based on the touch event being detected for the display module 160.

In an embodiment, the user input may be sensing information obtained by a controller (for example, the external electronic device 102 of FIG. 1). In an embodiment, the controller may acquire sensing information for controlling a virtual object in the state in which communication with the electronic device 101 is established. The controller may include a device such as a glove or a smart ring but is not limited thereto. The electronic device 101 may change the information related to the first object, based on information related to a user's gesture acquired by the controller.

In an embodiment, the electronic device 101 may change at least one of the location, the rotation angle, and/or the attribute information of the first object in the spatial coordinates of the first image, based on a user input. For example, based on a user's gesture being detected, the electronic device 101 may remap the location of the first object to the spatial coordinates of the first image, so as to remotely control the location of the first object generated by the external electronic device. In an embodiment, based on a user input of selecting the first object being acquired, the electronic device 101 may display a function bar for controlling the first object through the display module 160. In an embodiment, the function bar may include at least one option for movement within an area of the first image, movement within an area of the image acquired by the electronic device 101, or a change in the attribute information of the first object. The example of the function bar is not limited thereto. In an embodiment, the electronic device 101 may identify composition of the first object disposed in at least a partial area of the first image by moving the first object within the area of the first image. For example, when the first image is a reality image of the living room, the electronic device 101 may identify in advance the composition of the living room in which furniture is placed by moving the first object in a future shape within the area of the first image during a video call with the external electronic device. In an embodiment, the electronic device may identify the first object disposed in at least a partial area of the first image by changing the attribute information of the first object. For example, the electronic device 101 may identify in advance various colors of a frame for a picture on the wall by changing color information of the first object in a frame shape during a video call with the external electronic device.

In operation 307, in an embodiment, the electronic device 101 may transmit the changed information associated with the first object to the external electronic device.

In an embodiment, the electronic device 101 may transmit at least one of the location, the rotation angle, and/or the attribute information of the first object in at least a partial area of the display module 160 corresponding to the first image changed based on a user input to the external electronic device through a media session. For example, when the location of the first object in the spatial coordinates of the first image is remapped, the electronic device 101 may transmit the changed coordinates of the first object to the external electronic device. In an embodiment, the external electronic device may change the information related to the first object transmitted to the electronic device 101, based on the changed information related to the first object. The external electronic device may further change the information related to the first object, based on a user input for the external electronic device.

In operation 309, in an embodiment, the electronic device 101 may obtain the information associated with the first object changed by the external electronic device.

In an embodiment, the electronic device 101 may obtain the information associated with the first object further changed by the external electronic device after operation 307. For example, when the location, the rotation angle, and/or the attribute information of the first object is further changed by the external electronic device, the electronic device 101 may acquire the information related to the first object from the external electronic device through a media session. After operation 303, when communication with the external electronic device has been established, the electronic device 101 may acquire the first image from the external electronic device. For example, when the spatial coordinates of the first image is changed by movement of the external electronic device, the electronic device 101 may acquire the changed spatial coordinates of the first image from the external electronic device.

In operation 311, in an embodiment, the electronic device 101 may display the first object, based on the information changed by the external electronic device.

In an embodiment, the electronic device 101 may display the first image and the first object through the display module 160, based on the information further changed by the external electronic device. In an embodiment, the electronic device 101 may control the virtual object in an inverse object by exchanging virtual object information mapped to the reality image in real time while the image is shared with the external electronic device.

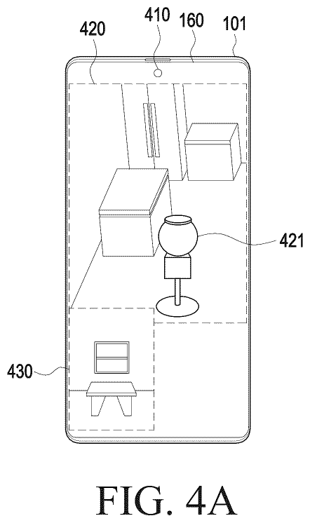

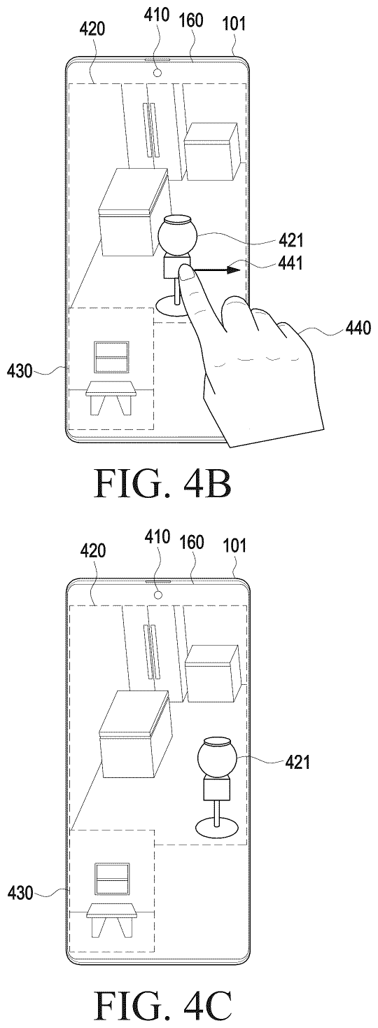

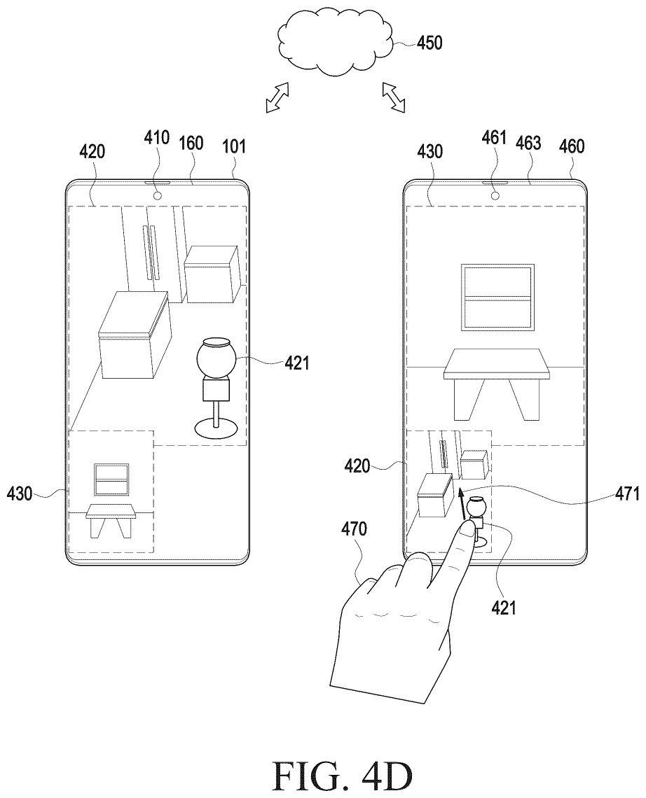

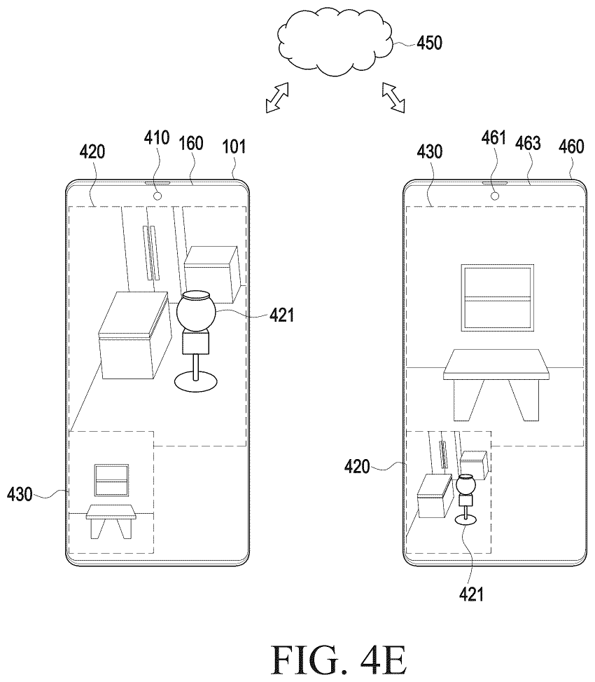

FIGS. 4A, 4B, 4C, 4D, and 4E are diagrams illustrating an example in which an electronic device (for example, the electronic device 101 of FIG. 2) controls virtual objects obtained from an external electronic device (for example, the electronic device 102 or the electronic device 104 of FIG. 1) according to various embodiments of the disclosure.

Referring to FIG. 4A, in an embodiment, the electronic device 101 may share a first image 420 and a second image 430 with the external electronic device and display a first object 421 in an area of the first image 420.

In an embodiment, the electronic device 101 may display the first image 420 and the first object 421 through a display module (for example, the display module 160 of FIG. 2), based on information obtained from the external electronic device. In an embodiment, when an additional function of virtual information is obtained based on a user input, the electronic device 101 may obtain spatial coordinates of the first image 420 and information associated with the first object 421 from the external electronic device. In an embodiment, the electronic device 101 may display the first image 420 obtained from the external electronic device in at least a partial area of the display module 160. The first image 420 may be a reality image obtained by the external electronic device. The electronic device 101 may display the first object 421 obtained from the external electronic device in at least a partial area of the area in which the first image 420 is displayed. In an embodiment, the electronic device 101 may display the first object 421 in a layer higher than the first image 420 by disposing the first object 421 in modeled three-dimensional spatial coordinates. The first object 421 may be a virtual object generated by the external electronic device. Referring to FIG. 4A, the first object 421 may be a virtual object in a furniture shape, but there is no limitation. In an embodiment, the information associated with the first object 421 may include a location of the first object 421 in the spatial coordinates of the first image 420, a rotation angle of the first object 421, and attribute information of the first object 421. The electronic device 101 may display mixed reality obtained by anchoring the virtual object to the reality space by displaying the first image 420 and the first object 421.

In an embodiment, the electronic device 101 may further display the second image 430 obtained by a camera module (for example, the camera module 180 of FIG. 2) on the display module 160. For example, the electronic device 101 may control the display module 160 to display an image obtained by a front camera 410 or the second image 430 obtained by a rear camera. The electronic device 101 may transmit the second image 430 obtained by the camera module 180 to the external electronic device through the communication module 190. The electronic device 101 may share the image with the external electronic device in real time by displaying the first image 420 obtained from the external electronic device or the second image 430 obtained by the camera module 180 through the display module 160.

Referring to FIG. 4B, in an embodiment, the electronic device 101 may change information associated with the first object 421.

In an embodiment, the electronic device 101 may change the information associated with the first object 421, based on a user input 440 in the state in which communication with the external electronic device is established. In an embodiment, the user input 440 may be a gesture detected based on an image obtained by the camera module 180. For example, based on an image obtained by the front camera 410 or a rear camera, the electronic device 101 may detect a gesture of a user's body. In an embodiment, based on identification that the image acquired by the front camera 410 is shared with the external electronic device, the electronic device 101 may detect a gesture, based on the image acquired by the rear camera. In an embodiment, based on identification that the image acquired by the rear camera is shared with the external electronic device, the electronic device 101 may detect a gesture, based on the image acquired by the front camera 410. In an embodiment, the electronic device 101 may detect a gesture, based on an image acquired by one of the front camera 410 and the rear camera, and transmit the image to the external electronic device. For example, the electronic device 101 may detect a gesture, based on an image acquired by the front camera 410, and transmit the image acquired by the front camera 410 to the external electronic device. The electronic device 101 may detect a gesture, based on the image acquired by the rear camera and transmit the image acquired by the rear camera to the external electronic device.

In an embodiment, the user input 440 may be a touch event for the display module 160. The electronic device 101 may change the information associated with the object 421, based on the touch event being detected for the display module 160.

In an embodiment, the user input 440 may be sensing information obtained by a controller. In an embodiment, the controller may acquire sensing information for controlling a virtual object in the state in which communication with the electronic device 101 is established. The controller may include a device such as a glove or a smart ring but is not limited thereto. The electronic device 101 may change the information associated with the first object 421, based on information associated with the user's gesture acquired by the controller.

In an embodiment, the electronic device 101 may change at least one of a location, a rotation angle, and/or attribute information of the first object 421 in the spatial coordinates of the first image 420, based on the user input 440. For example, the electronic device 101 may move the location of the first object 421, based on a user's detection being detected as indicated by reference numeral 441. The electronic device 101 may remotely control the location of the first object 421 generated by the external electronic device by remapping the first object 421 to the spatial coordinates of the first image.

Referring to FIG. 4C, in an embodiment, the electronic device 101 may identify composition of the first object 421 disposed in at least a partial area of the first image 420 by moving the first object 421 within the area of the first image 420. For example, when the first image 420 is a reality image of the living room, the electronic device 101 may identify in advance the composition of the living room in which furniture is disposed by moving the first object 421 in the furniture shape within the area of the first image 420 during a video call with the external electronic device.

Referring to FIG. 4D, in an embodiment, the electronic device 101 may transmit the changed information associated with the first object to the external electronic device 460.

In an embodiment, the electronic device 101 may transmit at least one of the location, the rotation angle, and/or the attribute information of the first object 421 changed based on a user input (for example, the user input 440 of FIG. 4B) to the external electronic device 460 through a network 450 (for example, the first network 198 or the second network 199 of FIG. 1). For example, the electronic device 101 may transmit the coordinates of the first object 421 remapped to the spatial coordinates of the first image 420 to the external electronic device 460. In an embodiment, the external electronic device 460 may change the information associated with the first object 421 transmitted to the electronic device 101, based on the changed information related to the first object 421. The external electronic device 460 may display the first image 420, the first object 421, and the second image 430 through a display module 463 of the external electronic device 460. The external electronic device 460 may further change the information related to the first object 421, based on a user input 470 for the external electronic device 460. In an embodiment, the external electronic device 460 may detect the user input 470, based on an image acquired by a front camera 461 of the external electronic device 460. For example, the external electronic device 460 may move the first object 421 within the first image 420, based on the user input 470 for the external electronic device 460 as indicated by reference numeral 471.

Referring to FIG. 4E, in an embodiment, the electronic device 101 may obtain the information associated with the first object 421 changed by the external electronic device 460.

In an embodiment, the electronic device 101 may obtain the information associated with the first object 421 further changed by the external electronic device 460. In an embodiment, the electronic device 101 may display the first object 421 through the display module 160, based on the information further changed by the external electronic device 460. Referring to FIG. 4E, the electronic device 101 may display the first image 420 and the first object 421 through the display module 160, based on the information related to the first object 421 changed according to a user input (for example, the user input 470 of FIG. 4D) for the external electronic device 460. In an embodiment, the electronic device 101 may control the virtual object in an inverse direction by exchanging virtual object information mapped to the reality image in real time while the image is shared with the external electronic device 460.

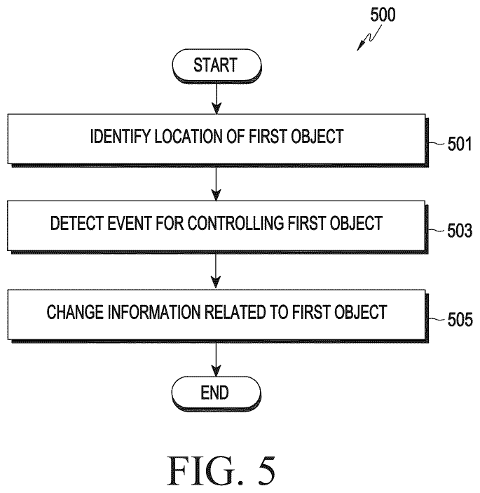

FIG. 5 is a flowchart 500 illustrating an operation in which an electronic device (for example, the electronic device 101 of FIG. 2) changes object-related information, based on an event for controlling a virtual object being detected, according to an embodiment of the disclosure.

In an embodiment, operations illustrated in FIG. 5 are not limited to the illustrated orders, but may be performed in various orders. According to an embodiment, more operations than the operations illustrated in FIG. 5 may be performed, or at least one operation fewer than illustrated may be performed.

Referring to FIG. 5, in operation 501, the electronic device 101 (for example, the processor 120 of FIG. 2) may identify a location of a first object (for example, the first object 421 of FIG. 4A) in an embodiment.

In an embodiment, the electronic device 101 may identify the location of the first object 421 in spatial coordinates of a first image (for example, the first image 420 of FIG. 4A). The electronic device 101 may identify the location of the first object 421 in the spatial coordinates of the first image 420, based on the spatial coordinates of the first image and information related to the first object obtained from an external electronic device (For example, the external electronic device 460 of FIG. 4D).

In operation 503, in an embodiment, the electronic device 101 may detect an event for controlling the first object 421.

In an embodiment, the electronic device 101 may detect the event for controlling the first object 421, based on a user input for an area corresponding to the location of the first object 421.

In an embodiment, the electronic device 101 may identify movement for controlling the first object 421 from the image obtained by the camera module 180 and detect the event for controlling the first object 421, based on the identified movement. The electronic device 101 may control the first object 421, based on whether movement for controlling the first object 421 is detected within the area corresponding to the first object 421.

In an embodiment, the electronic device 101 may establish communication with a controller (for example, the electronic device 102 of FIG. 1) through a communication module (for example, the communication module 190 of FIG. 1) and detect an event for controlling the first object 421, based on sensing information obtained from the controller (for example, the electronic device 102 of FIG. 1). The electronic device 101 may control the first object 421, based on whether the spatial coordinates corresponding to the sensing information is located within the area corresponding to the first object 421.

In an embodiment, the electronic device 101 may detect the event for controlling the first object 421, based on the sensing information obtained by the display module 160. The electronic device 101 may control the first object 421, based on whether the coordinates corresponding to sensing information is located within the area corresponding to the first object 421.

In operation 505, in an embodiment, the electronic device 101 may change the information associated with the first object.

In an embodiment, the electronic device 101 may change information associated with the first object 421, based on the event for controlling the first object 421 being detected. The electronic device 101 may control the first object 421 generated by the external electronic device 460 by changing at least one of the location, the rotation angle, and/or the attribute information of the first object 421.

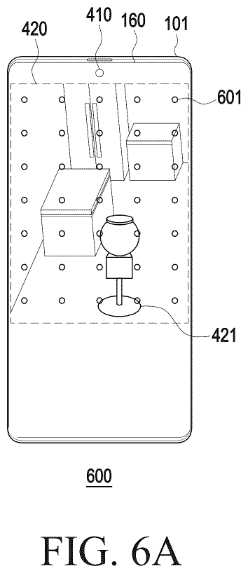

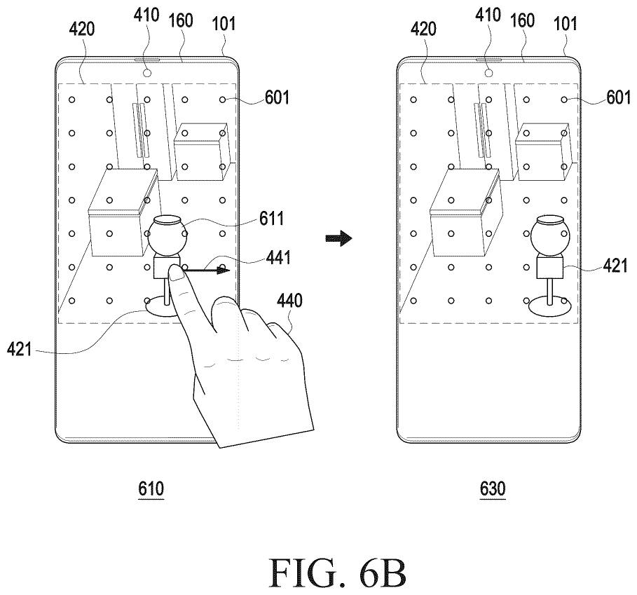

FIGS. 6A and 6B are diagrams illustrating an example in which an electronic device (for example, the electronic device 101 of FIG. 2) changes object-related information, based on an event for controlling a virtual object being detected according to various embodiments of the disclosure.

Referring to reference numeral 600 of FIG. 6A, in an embodiment, the electronic device 101 (for example, the processor 120 of FIG. 2) may identify the location of the first object 421. In an embodiment, the electronic device 101 may identify the location of the first object 421 in spatial coordinates of the first image 420. The electronic device 101 may identify the location of the first object 421 in the spatial coordinates of the first image 420, based on the spatial coordinates of the first image 420 and information associated with the first object 421 obtained from the external electronic device 460. Referring to FIG. 6A, the electronic device 101 may identify the location of the first object 421, based on coordinates of one or more features 601 for the first image 420.

Referring to reference numeral 610 of FIG. 6B, in an embodiment, the electronic device 101 may change information associated with the first object 421, based on an event for controlling the first object 421 being detected. In an embodiment, the electronic device 101 may detect the event for controlling the first object 421, based on the user input 440 for the area corresponding to the location of the first object 421. In an embodiment, the electronic device 101 may detect the event for controlling the first object 421, based on the user input 440 for at least one feature 611 in the area corresponding to the location of the first object 621 among the one or more features 601 for the first image 420. In an embodiment, the electronic device 101 may move the first object 421, based on the user input 440 for the feature 611 in the area corresponding to the location of the first object 421 as indicated by reference numeral 441. In an embodiment, the electronic device 101 may change information associated with the first object 421, based on the event for controlling the first object 421 being detected. The electronic device 101 may control the first object 421 generated by the external electronic device 460 by changing at least one of the location, the rotation angle, and/or the attribute information of the first object 421.

In an embodiment, referring to reference numeral 630, the electronic device 101 may display the first object 421 in the area of the first image 420, based on the changed information associated with the first object 421. The electronic device 101 may transmit the changed information associated with the first object 421 to the external electronic device 460.

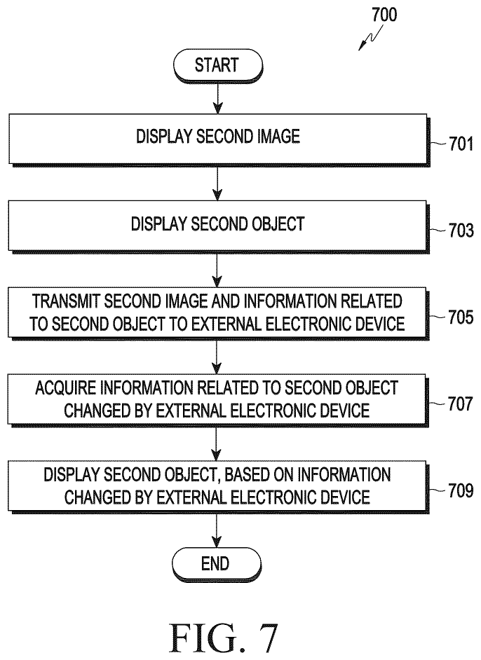

FIG. 7 is a flowchart 700 illustrating an operation in which an electronic device (for example, the electronic device 101 of FIG. 2) generates virtual objects and transmits information associated with the generated virtual objects to an external electronic device (for example, the electronic device 102 of FIG. 1, the electronic device 102 of FIG. 1, or the external electronic device 460 of FIG. 4D) according to an embodiment of the disclosure.

In an embodiment, operations illustrated in FIG. 7 are not limited to the illustrated orders, but may be performed in various orders. According to an embodiment, more operations than the operations illustrated in FIG. 7 may be performed, or at least one operation fewer than illustrated may be performed.

Referring to FIG. 7, in operation 701, the electronic device 101 (For example, the processor 120 of FIG. 2) may display a second image (for example, the second image 430 of FIG. 4A) in an embodiment.

In an embodiment, the electronic device 101 may display the second image 430 obtained by a camera module (for example, the camera module 180 of FIG. 2) through the display module 160. For example, the electronic device 101 may control the display module 160 to display the second image 430 obtained by a front camera (for example, the front camera 410 of FIG. 4A) or the second image 430 obtained by a rear camera.

In operation 703, in an embodiment, the electronic device 101 may display a second object.

In an embodiment, the electronic device 101 may display the second object in at least a partial area of the display module 160 in which the second image 430 is displayed, based on a user input. In an embodiment, when an additional function of virtual information is activated based on a user input, the electronic device 101 may display the second object in at least a partial area of the display module 160 in which the second image 430 is displayed. In an embodiment, the second object may be a virtual object in a shape such as furniture, a picture, or a pet, but there is no limitation.

In operation 705, in an embodiment, the electronic device 101 may transmit the second image 430 and information associated with the second object to the external electronic device 460.

In an embodiment, the electronic device 101 may transmit the second image 430 obtained by the camera module 180 to the external electronic device 460 through a communication module (for example, the communication module 190 of FIG. 1). The electronic device 101 may transmit spatial coordinates of the second image 430 to the external electronic device 460. The electronic device 101 may store in advance the spatial coordinates of the second image 430 and the information related to the second object. In an embodiment, the spatial coordinates of the second image 430 and the information related to the second object may be stored in advance in a server (for example, the server 108 of FIG. 1).

In operation 707, in an embodiment, the electronic device 101 may obtain (or receive) the changed information associated with the second object from the external electronic device 460.

In an embodiment, the electronic device 101 may obtain, from the external electronic device 460, the information associated with the second object changed by the external electronic device 460. In an embodiment, the external electronic device 460 may change the information related to the second object transmitted by the electronic device 101, based on the changed information related to the second object. The external electronic device 460 may change the information related to the second object, based on a user input for the external electronic device 460.

In operation 709, in an embodiment, the electronic device 101 may display the second object, based on the information changed by the external electronic device 460.

In an embodiment, the electronic device 101 may display the second object through the display module 160, based on the information changed by the external electronic device 460. In an embodiment, the electronic device 101 may control the virtual object in an inverse object by exchanging virtual object information mapped to the reality image in real time while the image is shared with the external electronic device.

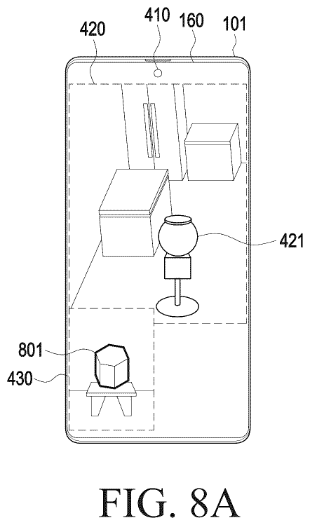

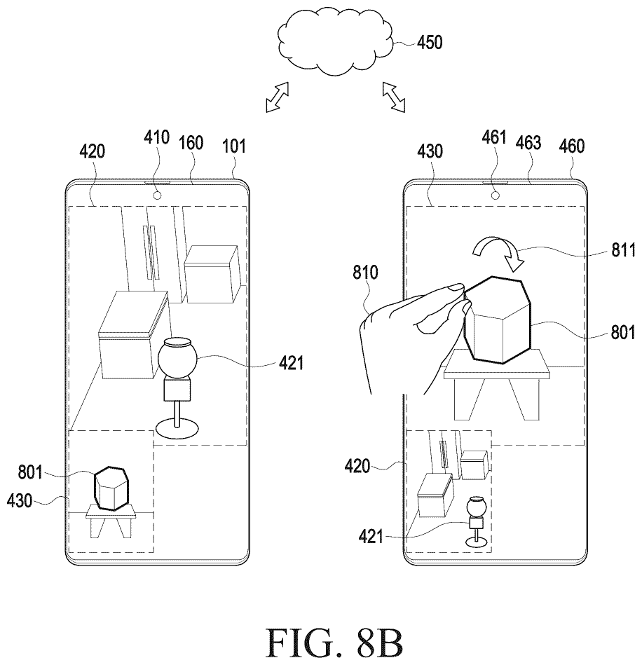

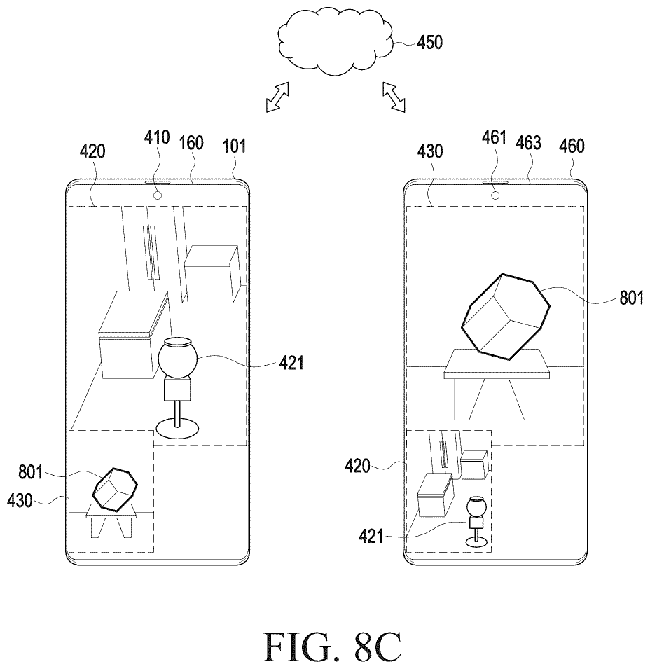

FIGS. 8A, 8B, and 8C are diagrams illustrating an example in which an electronic device (for example, the electronic device 101 of FIG. 2) generates virtual objects and displays the generated virtual objects, based on information obtained by an external electronic device (for example, the electronic device 102 of FIG. 1, the electronic device 102 of FIG. 2, or the external electronic device 460 of FIG. 4D) according to various embodiments of the disclosure.

Referring to FIG. 8A, in an embodiment, the electronic device 101 (for example, the processor 120 of FIG. 2) may display the second image 430 and a second object 801.

In an embodiment, the electronic device 101 may display the second image 430 obtained by a camera module (for example, the camera module 180 of FIG. 2) through the display module 160. For example, the electronic device 101 may control the display module 160 to display the second image 430 acquired by the front camera 410 or the second image 430 acquired by the rear camera. In an embodiment, the electronic device 101 may display the second object 801 in at least a partial area of the display module 160 in which the second image 430 is displayed based on a user input. In an embodiment, when an additional function of virtual information is activated based on a user input, the electronic device 101 may display the second object 801 in at least a partial area of the display module 160 in which the second image 430 is displayed. In an embodiment, the second object 801 may be a virtual object displayed in a layer higher than the reality image.

Referring to FIG. 8B, in an embodiment, the electronic device 101 may transmit the second image 430 and information associated with the second object 801 to the external electronic device 460 through the network 450 (for example, the first network 198 or the second network 199 of FIG. 1).

In an embodiment, the electronic device 101 may transmit the second image 430 obtained by the camera module 180 to the external electronic device 460 through a communication module (for example, the communication module 190 of FIG. 1). The electronic device 101 may transmit spatial coordinates of the second image 430 to the external electronic device 460. The electronic device 101 may store in advance the spatial coordinates of the second image 430 and the information related to the second object. In an embodiment, the spatial coordinates of the second image 430 and the information related to the second object may be stored in advance in a server (for example, the server 108 of FIG. 1). In an embodiment, the external electronic device 460 may display the second image 430 and the second object 801 through the display module 463 of the external electronic device 460, based on the information related to the second object 801 transmitted by the electronic device 101. The external electronic device 460 may change the information related to the second object, based on a user input 810 for the external electronic device 460. For example, the external electronic device 460 may change a rotation angle of a second object 801, based on the user input 810 for the external electronic device 460 as indicated by reference numeral 811.

Referring to FIG. 8C, in an embodiment, the electronic device 101 may obtain changed information associated with the second object 801 from the external electronic device 460. The electronic device 101 may display the second object 801, based on the information changed by the external electronic device 460. For example, the electronic device 101 may display the second object 801 in at least a partial area of the second image 430, based on the rotation angle of the second object 801 changed by the external electronic device 460. In an embodiment, the electronic device 101 may control the virtual object in an inverse object by exchanging virtual object information mapped to the reality image in real time while the image is shared with the external electronic device.

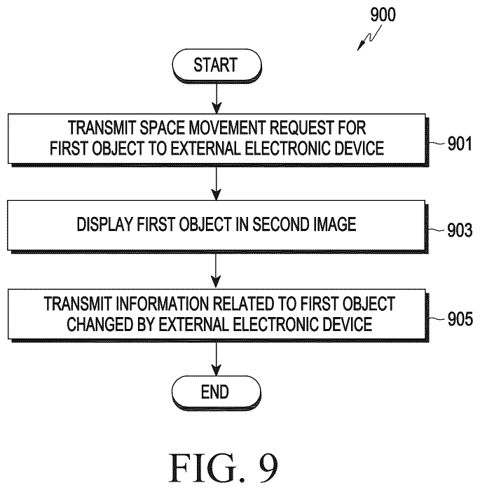

FIG. 9 is a flowchart 900 illustrating an operation in which an electronic device (for example, the electronic device 101 of FIG. 2) changes spatial information of ownership of virtual objects generated by an external electronic device (for example, the electronic device 102 of FIG. 1, the electronic device 102 of FIG. 1, or the external electronic device 460 of FIG. 4D) according to an embodiment of the disclosure.

In an embodiment, operations illustrated in FIG. 9 are not limited to the illustrated orders, but may be performed in various orders. According to an embodiment, more operations than the operations illustrated in FIG. 9 may be performed, or at least one operation fewer than illustrated may be performed.

Referring to FIG. 9, in operation 901, the electronic device 101 (for example, the processor 120 of FIG. 2) may transmit a spatial movement request for a first object (for example, the first object 421 of FIG. 4A) to the external electronic device 460 in an embodiment.

In an embodiment, the electronic device 101 may transmit a request for changing spatial information of the first object 421 to the external electronic device 460, based on a user input. In an embodiment, the spatial movement request for the first object 421 may be a request for mapping the first object 421 to a second image (for example, the second image 430 of FIG. 4A) from a first image (for example, the first image 420 of FIG. 4A) by changing the spatial information of the first object 421. In an embodiment, the user input may be an event of moving the location of the first object 421 from the first image 420 to the second image 430 but is not limited thereto. Based on the spatial movement request from the electronic device 101 being acquired, the external electronic device 460 may transmit a response to the request to the electronic device 101, based on communication with a server (for example, the server 108 of FIG. 1). In an embodiment, based on communication with the server 108, the external electronic device 460 may transmit a spatial movement response to the electronic device 101, based on identification that the spatial movement request acquired from the electronic device 101 is valid. Based on communication with the server 108, the external electronic device 460 may transmit a space maintenance response to the electronic device 101, based on identification that the spatial movement request acquired from the electronic device 101 is not valid.

In an embodiment, the first object 421 may be a virtual object of which ownership can be identified based on a non-fungible token (NFT). In an embodiment, the spatial movement request for the first object 421 may be a request for changing ownership for the first object 421. The change in ownership may be an operation of changing the owner of the virtual object, based on a virtual token that proves possession of digital assets using blockchain technology such as NFT. In an embodiment, the electronic device 101 may transmit a request for changing the ownership of the first object 421 to the external electronic device 460. The external electronic device 460 may transmit a request for changing the owner of the first object 421 from the user of the external electronic device 460 to the user of the electronic device 101 to a server that manages the ownership of the virtual object, based on the request for changing the ownership being received. In an embodiment, the server that manages the ownership may change the owner of the first object 421 from the user of the external electronic device 460 to the user of the electronic device 101, based on the request received from the external electronic device 460. In an embodiment, the server that manages the ownership may transmit a response to the change in the ownership of the first object 421 to the external electronic device 460 and/or the electronic device 101.

In operation 903, in an embodiment, the electronic device 101 may display the first object 421 in the area of the second image 430.

In an embodiment, the electronic device 101 may display the first object 421 in at least a partial area of the area in which the second image 430 is displayed, based on the spatial movement response generated based on the request, being obtained (or received) from the external electronic device 460. In an embodiment, the electronic device 101 may control the first object 421 within the second image 430 by displaying the first object 421 in the second image 430.

In operation 905, in an embodiment, the electronic device 101 may transmit the changed information associated with the first object 421 to the external electronic device 460.

In an embodiment, the electronic device 101 may transmit the second image 430, spatial information of the second image, and information associated with the first object 421 disposed within the second image 430 to the external electronic device 460. The external electronic device 460 may display the second image 430, based on the information obtained from the electronic device 101 and display the first spatially moved first object 421 in the second image 430.

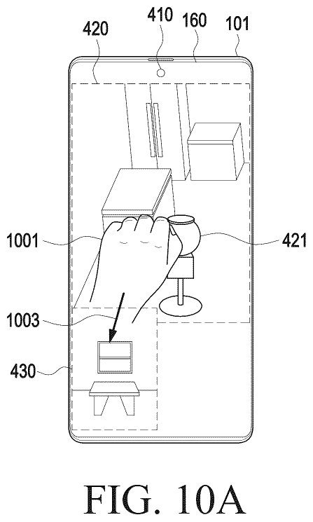

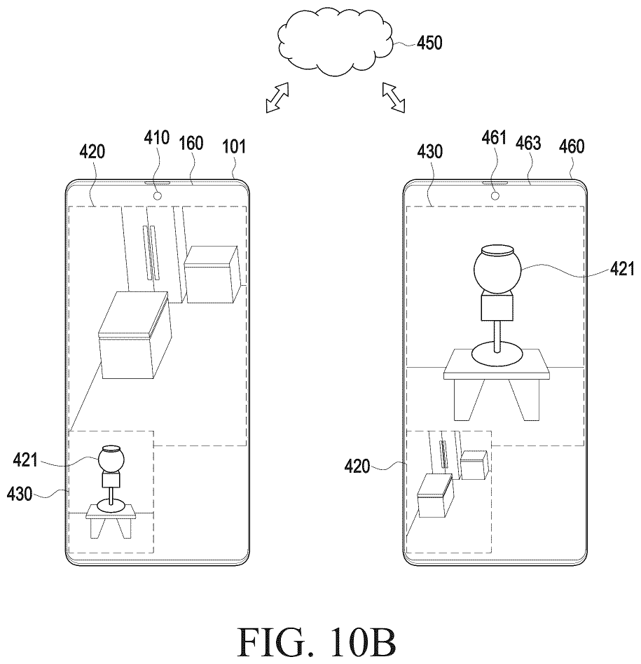

FIGS. 10A and 10B are diagrams illustrating an example in which an electronic device (for example, the electronic device 101 of FIG. 2) changes ownership of virtual objects generated by an external electronic device (for example, the electronic device 102 of FIG. 1, the electronic device 102 of FIG. 1, or the external electronic device 460 of FIG. 4D) according to various embodiments of the disclosure.

Referring to FIG. 10A, in an embodiment, the electronic device 101 (for example, the processor 120 of FIG. 2) may transmit a spatial movement request for the first object 421 to the external electronic device (for example, the external electronic device 460 of FIG. 4A), based on a user input 1001. In an embodiment, the user input 1001 may be an event of moving the location of the first object 421 from the first image 420 to the second image 430 as indicated by reference numeral 1003 but is not limited thereto. Based on the spatial movement request from the electronic device 101 being obtained, the external electronic device 460 may transmit a response to the request to the electronic device 101, based on communication with a server (for example, the server 108 of FIG. 1). In an embodiment, based on communication with the server 108, the external electronic device 460 may transmit a spatial movement response to the electronic device 101, based on identification that the spatial movement request obtained from the electronic device 101 is valid. Based on communication with the server 108, the external electronic device 460 may transmit a space maintenance response to the electronic device 101, based on identification that the spatial movement request acquired from the electronic device 101 is not valid.

In an embodiment, the first object 421 may be a virtual object of which ownership can be identified based on an NFT. In an embodiment, the spatial movement request for the first object 421 may be a request for changing ownership of the first object 421. In an embodiment, the change in ownership may be an operation of changing the ownership of the virtual object, based on blockchain technology such as the NFT. In an embodiment, the electronic device 101 may transmit a request for changing the ownership of the first object 421 to the external electronic device 460. The external electronic device 460 may transmit a request for changing the owner of the first object 421 from the user of the external electronic device 460 to the user of the electronic device 101 to a server that manages the ownership of the virtual object, based on the request for changing the ownership being received. In an embodiment, the server that manages the ownership may change the owner of the first object 421 from the user of the external electronic device 460 to the user of the electronic device 101, based on the request received from the external electronic device 460. In an embodiment, the server that manages the ownership may transmit a response to the change in the ownership of the first object 421 to the external electronic device 460 and/or the electronic device 101.

Referring to FIG. 10B, in an embodiment, the electronic device 101 may display the first object 421 in the area of the second image 430, based on a spatial movement response generated based on the request, being obtained (or received) from the external electronic device 460. In an embodiment, the electronic device 101 may display the first object 421 in at least a partial area of the area in which the second image 430 is displayed. In an embodiment, the electronic device 101 may control the first object within the second image 430 by displaying the first object 421 in the second image 430.

The electronic device 101 may transmit the changed information associated with the first object 421 to the external electronic device 460. In an embodiment, the electronic device 101 may transmit the second image 430, spatial information of the second image, and information related to the first object 421 disposed within the second image 430 to the external electronic device 460. The external electronic device 460 may display the second image 430, based on the information obtained from the electronic device 101 and display the first object 421 of which the ownership is changed in the second image 430. In an embodiment, the electronic device 101 may perform spatial movement of the virtual object and/or change the ownership, based on the information related to the virtual object being exchanged with the external electronic device 460.

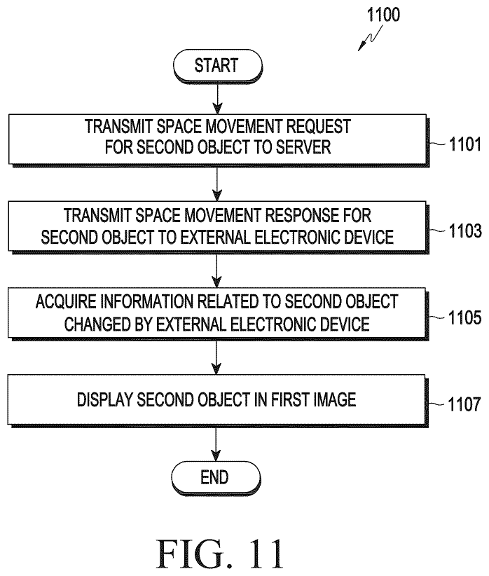

FIG. 11 is a flowchart 1100 illustrating an operation in which an electronic device (for example, the electronic device 101 of FIG. 2) transmits a spatial movement request for a virtual object to a server (for example, the server 108 of FIG. 1) according to an embodiment of the disclosure.

In an embodiment, operations illustrated in FIG. 11 are not limited to the illustrated orders, but may be performed in various orders. According to an embodiment, more operations than the operations illustrated in FIG. 11 may be performed, or at least one operation fewer than illustrated may be performed.

Referring to FIG. 11, in operation 1101, the electronic device 101 (for example, the processor 120 of FIG. 2) may transmit a spatial movement request for a second object (for example, the second object 801 of FIG. 8A) to the server 108 in an embodiment.

In an embodiment, the electronic device 101 may transmit the spatial movement request for the second object 801 to the server 108, based on the spatial movement request for the second object 801 being obtained from an external electronic device (for example, the external electronic device 460 of FIG. 4D). In an embodiment, the spatial movement request for the first object 421 may be a request for mapping the first object 421 to a second image (for example, the second image 430 of FIG. 4A) from a first image (for example, the first image 420 of FIG. 4A) by changing the spatial information of the first object 421. In an embodiment, when the spatial movement request obtained from the external electronic device 460 is valid, the electronic device 101 may acquire a spatial movement response from the server 108. In an embodiment, when the spatial movement request acquired from the external electronic device 460 is not valid, the electronic device 101 may acquire a space maintenance response from the server 108.

In operation 1103, in an embodiment, the electronic device 101 may transmit the spatial movement response of the second object to the external electronic device (for example, the electronic device 102 of FIG. 1, the electronic device 102 of FIG. 1, or the external electronic device 460 of FIG. 4D).

In an embodiment, the electronic device 101 may transmit the spatial movement response of the second object 801 to the external electronic device 460, based on the spatial movement response generated based on the request, being obtained (or received) from the server 108.

In an embodiment, the first object 421 may be a virtual object of which ownership can be identified based on an NFT. In an embodiment, the spatial movement request for the first object 421 may be a request for changing ownership of the first object 421. In an embodiment, the change in ownership may be an operation of changing the ownership of the virtual object, based on blockchain technology such as the NFT. In an embodiment, the electronic device 101 may transmit a request for changing the ownership of the first object 421 to the external electronic device 460. The external electronic device 460 may transmit a request for changing the owner of the first object 421 from the user of the external electronic device 460 to the user of the electronic device 101 to a server that manages the ownership of the virtual object, based on the request for changing the ownership being received. In an embodiment, the server that manages the ownership of the virtual object may be a server different from the server 108 that manages space information of the virtual object and/or space information of the three-dimensional space obtained by the camera. In an embodiment, the server that manages the ownership may change the owner of the first object 421 from the user of the external electronic device 460 to the user of the electronic device 101, based on the request received from the external electronic device 460. In an embodiment, the server that manages the ownership may transmit a response to the change in the ownership of the first object 421 to the external electronic device 460 and/or the electronic device 101.

In operation 1105, in an embodiment, the electronic device 101 may obtain information associated with the second object changed by the external electronic device 460.

In an embodiment, the electronic device 101 may obtain information associated with the second object 801 changed by the external electronic device 460 from the external electronic device 460. In an embodiment, the information related to the second object 801 may include at least one of a location, a rotation angle, and/or attribute information of the second object 801 of which the location is changed from a second image (for example, the second image 430 of FIG. 4A) to a first image (for example, the first image 420 of FIG. 4A).

In operation 1107, in an embodiment, the electronic device 101 may display the second object in the area of the first image.

In an embodiment, the electronic device 101 may display the second object 801 in at least a partial area of the display module 160 on which the first image 420 is displayed, based on information changed by the external electronic device 460. In an embodiment, the electronic device 101 may perform spatial movement of the virtual object and/or change the ownership, based on the information related to the virtual object being exchanged with the external electronic device 460.

An electronic device (for example, the electronic device 101 of FIG. 1 or FIG. 2) according to an embodiment may be configured to include a communication module (for example, the communication module 190 of FIG. 1 or 2), a camera module (for example, the camera module 180 of FIG. 1 or 2), a display module (for example, the display module 160 of FIG. 1 or 2), memory (for example, the memory 130 of FIG. 1) storing instructions, and at least one processor (for example, the processor 120 of FIG. 1 or 2) operatively connected to the communication module 190, the camera module 180, the display module 160, and the memory 130. The instructions may cause, when executed by the at least one processor 120, the electronic device 101 to establish communication with an external electronic device 102, 104, or 460 through the communication module 190. The instructions may cause, when executed by the at least one processor 120, the electronic device 101 to display a first image 420 and a first object 421 through the display module 160, based on information obtained from the external electronic device 102, 104, or 460. The instructions may cause, when executed by the at least one processor 120, the electronic device 101 to change information associated with the first object 421, based on a user input. The instructions may cause, when executed by the at least one processor 120, the electronic device 101 to transmit the changed information associated with the first object 421 to the external electronic device 102, 104, or 460. The instructions may cause, when executed by the at least one processor 120, the electronic device 101 to obtain the information associated with the first object 421 changed by the external electronic device 102, 104, or 460 from the external electronic device 102, 104, or 460. The instructions may cause, when executed by the at least one processor 120, the electronic device 101 to display the first object 421 through the display module 160, based on information changed by the external electronic device 102, 104, or 460.

In an embodiment, the information obtained from the external electronic device 102, 104, or 460 may include spatial coordinates of the first image 420 and the information related to the first object 421.

In an embodiment, the information associated with the first object 421 may include a location of the first object 421 in the spatial coordinates of the first image 420, a rotation angle of the first object 421, and attribute information of the first object 421.

In an embodiment, the instructions may cause, when executed by the at least one processor 120, the electronic device 101 to identify the location of the first object 421 in the spatial coordinates of the first image 420. The instructions may cause, when executed by the at least one processor 120, the electronic device 101 to detect an event for controlling the first object 421, based on a user input to an area corresponding to the location of the first object 421. The instructions may cause, when executed by the at least one processor 120, the electronic device 101 to, based on detecting the event, change the information associated with the first object 421.

In an embodiment, the instructions may cause, when executed by the at least one processor 120, the electronic device 101 to identify a movement for controlling the first object 421 from an image obtained by the camera module 180. The instructions may cause, when executed by the at least one processor 120, the electronic device 101 to detect an event for controlling the first object 421, based on the movement.

In an embodiment, the instructions may cause, when executed by the at least one processor 120, the electronic device 101 to establish communication with a controller (for example, the electronic device 102 of FIG. 1) through the communication module 190. The instructions may cause, when executed by the at least one processor 120, the electronic device 101 to detect the event for controlling the first object 421, based on sensing information obtained from the controller (for example, the electronic device 102 of FIG. 1).

In an embodiment, the instructions may cause, when executed by the at least one processor 120, the electronic device 101 to detect the event for controlling the first object 421, based on sensing information obtained by the display module 160.

In an embodiment, the instructions may cause, when executed by the at least one processor 120, the electronic device 101 to display a second image 430 obtained by the camera module 180 through the display module 160. The instructions may cause, when executed by the at least one processor 120, the electronic device 101 to display a second object 801 in at least a partial area of the display module 160 in which the second image 430 is displayed, based on a user input. The instructions may cause, when executed by the at least one processor 120, the electronic device 101 to transmit the second image 430 and information associated with the second object 801 to the external electronic device 102, 104, or 460. The instructions may cause, when executed by the at least one processor 120, the electronic device 101 to obtain information associated with the second object 801 changed by the external electronic device 102, 104, or 460 from the external electronic device 102, 104, or 460. The instructions may cause, when executed by the at least one processor 120, the electronic device 101 to display the second object 801 through the display module 160, based on information changed by the external electronic device 102, 104, or 460.

In an embodiment, the instructions may cause, when executed by the at least one processor 120, the electronic device 101 to transmit a spatial movement request for the first object 421 to the external electronic device 102, 104, or 460, based on a user input. The instructions may cause, when executed by the at least one processor 120, the electronic device 101 to display the first object 421 in at least a partial area of an area in which the second image 430 is displayed, based on receiving, from the external electronic device 102, 104, or 460, a spatial movement response generated based on the request. The instructions may cause, when executed by the at least one processor 120, the electronic device 101 to transmit spatial information of the second image 430 and the changed information associated with the first object 421 to the external electronic device 102, 104, or 460.

In an embodiment, the instructions may cause, when executed by the at least one processor 120, the electronic device 101 to transmit a spatial movement request for the second object 801 to a server 108, based on obtaining the spatial movement request for the second object 801 from the external electronic device 102, 104, or 460. The instructions may cause, when executed by the at least one processor 120, the electronic device 101 to transmit a spatial movement response for the second object 801 to the external electronic device 102, 104, or 460, based on receiving the spatial movement response generated based on the request from the server 108. The instructions may cause, when executed by the at least one processor 120, the electronic device 101 to obtain information associated with the second object 801 changed by the external electronic device 102, 104, or 460 from the external electronic device 102, 104, or 460. The instructions may cause, when executed by the at least one processor 120, the electronic device 101 to display the second object 801 in at least a partial area of the display module 160 in which the first image 420 is displayed, based on information changed by the external electronic device 102, 104, or 460.

A method of controlling an object by an electronic device 101 according to an embodiment may include an operation of establishing communication with an external electronic device 102, 104, or 460 through a communication module 190. The method may include an operation of displaying a first image 420 and a first object 421 through a display module 160, based on information obtained from an external electronic device 102, 104, or 460. The method may include an operation of changing information associated with the first object 421, based on a user input. The method may include an operation of transmitting the changed information associated with the first object 421 to the external electronic device 102, 104, or 460. The method may include an operation of obtaining the information associated with the first object 421 changed by the external electronic device 102, 104, or 460 from the external electronic device 102, 104, or 460. The method may include an operation of displaying the first object 421 through the display module 160, based on information changed by the external electronic device 102, 104, or 460.

In an embodiment, in the method, the information obtained from the external electronic device 102, 104, or 460 may include spatial coordinates of the first image 420 and the information associated with the first object 421.

In an embodiment, in the method, the information associated with the first object 421 may include a location of the first object 421 in the spatial coordinates of the first image 420, a rotation angle of the first object 421, and attribute information of the first object 421.

In an embodiment, in the method, the operation of changing the information associated with the first object 421 may include an operation of identifying the location of the first object 421 in the spatial coordinates of the first image 420. The method may include an operation of detecting an event for controlling the first object 421, based on a user input to an area corresponding to the location of the first object 421. The method may include, based on detecting the event, changing the information associated with the first object 421.

In an embodiment, in the method, the operation of detecting the event for controlling the first object 421 may include an operation of identifying a movement for controlling the first object 421 from an image obtained by the camera module 180. The method may include an operation of detecting the event for controlling the first object 421, based on the movement.

In an embodiment, in the method, the operation of detecting the event for controlling the first object 421 may include an operation of establishing communication with a controller (for example, the electronic device 102 of FIG. 1) through the communication module 190. The method may include an operation of detecting the event for controlling the first object 421, based on sensing information obtained from controller (for example, the electronic device 102 of FIG. 1).

In an embodiment, in the method, the operation of detecting the event for controlling the first object 421 may include an operation of detecting the event for controlling the first object 421, based on sensing information obtained by the display module 160.

In an embodiment, the method may further include an operation of displaying the second image 430 obtained by the camera module 180 through the display module 160. The method may further include an operation of displaying a second object 801 in at least a partial area of the display module 160 in which the second image 430 is displayed based on a user input. The method may further include an operation of transmitting the second image 430 and information associated with the second object 801 to the external electronic device 102, 104, or 460. The method may further include an operation of obtaining information associated with the second object 801 changed by the external electronic device 102, 104, or 460 from the external electronic device 102, 104, or 460. The method may further include an operation of displaying the second object 801 through the display module 160, based on information changed by the external electronic device 102, 104, or 460.

In an embodiment, the method may further include an operation of transmitting a spatial movement request for the first object 421 to the external electronic device 102, 104, or 460, based on a user input. The method may further include an operation of displaying the first object 421 in at least a partial area of an area in which the second image 430 is displayed, based on receiving a spatial movement response generated based on the request from the external electronic device 102, 104, or 460. The method may further include an operation of transmitting spatial information of the second image 430 and the changed information associated with the first object 421 to the external electronic device 102, 104, or 460.

In an embodiment, the method may further include an operation of transmitting a spatial movement request for the second object 801 to a server 108, based on obtaining the spatial movement request for the second object 801 from the external electronic device 102, 104, or 460. The method may further include an operation of transmitting a spatial movement response for the second object 801 to the external electronic device 102, 104, or 460, based on receiving the spatial movement response generated based on the request from the server 108. The method may further include an operation of obtaining information associated with the second object 801 changed by the external electronic device 102, 104, or 460 from the external electronic device 102, 104, or 460. The method may further include an operation of displaying the second object 801 in at least a partial area of the display module 160 in which the first image 420 is displayed, based on information changed by the external electronic device 102, 104, or 460.

A computer-readable storage medium storing instructions is provided. The instructions may cause an electronic device 101, when executed by at least one processor 120 of the electronic device 101, to perform operations. The operations may include an operation of establishing communication with an external electronic device 102, 104, or 460 through a communication module 190 of the electronic device 101. The operations may include an operation of displaying a first image 420 and a first object 421 through a display module 160 of the electronic device 101, based on information obtained from an external electronic device 102, 104, or 460. The operations may include an operation of changing information associated with the first object 421, based on a user input. The operations may include an operation of transmitting the changed information associated with the first object 421 to the external electronic device 102, 104, or 460. The operations may include an operation of obtaining the information associated with the first object 421 changed by the external electronic device 102, 104, or 460 from the external electronic device 102, 104, or 460. The operations may include an operation of displaying the first object 421 through the display module 160, based on information changed by the external electronic device 102, 104, or 460.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Further, the structures of data used in the embodiments described above may be recorded through various means in a computer-readable recording medium. The computer-readable recording medium includes recording media, such as a magnetic recording medium (for example, ROM, floppy disc, hard disc, etc.), an optical reading medium (for example, CD-ROM, digital versatile disc (DVD), etc.).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication module;
a camera module;
a display module;
memory, comprising one or more storage media, storing instructions; and
at least one processor communicatively coupled to the communication module, the camera module, the display module, and the memory,
wherein the instructions, when executed by the at least one processor individually or collectively, cause the electronic device to:
establish, through the communication module, communication with an external electronic device,
display, through the display module, a first image and a first object, based on information obtained from the external electronic device,
change information associated with the first object, based on a user input,
transmit, to the external electronic device, the changed information associated with the first object,
obtain, from the external electronic device, information associated with the first object changed by the external electronic device, and
display, through the display module, the first object, based on the information changed by the external electronic device.

2. The electronic device of claim 1, wherein the information obtained from the external electronic device comprises spatial coordinates of the first image and the information associated with the first object.

3. The electronic device of claim 2, wherein the information associated with the first object comprises:
a location of the first object in the spatial coordinates of the first image,
a rotation angle of the first object, and
attribute information of the first object.

4. The electronic device of claim 3, wherein the instructions, when executed by the at least one processor individually or collectively, further cause the electronic device to:
identify the location of the first object in the spatial coordinates of the first image,
detect an event for controlling the first object, based on a user input to an area corresponding to the location of the first object, and
based on detecting the event, change the information associated with the first object.

5. The electronic device of claim 1, wherein the instructions, when executed by the at least one processor individually or collectively, further cause the electronic device to:
identify a movement for controlling the first object from an image obtained by the camera module, and
detect an event for controlling the first object, based on the movement.

6. The electronic device of claim 5, wherein the instructions, when executed by the at least one processor individually or collectively, further cause the electronic device to:
establish, through the communication module, communication with a controller, and
detect the event for controlling the first object, based on sensing information obtained from the controller.

7. The electronic device of claim 6, wherein the instructions, when executed by the at least one processor individually or collectively, further cause the electronic device to:
detect the event for controlling the first object, based on sensing information obtained by the display module.

8. The electronic device of claim 1, wherein the instructions, when executed by the at least one processor individually or collectively, further cause the electronic device to:
display, through the display module, a second image obtained by the camera module,
display a second object in at least a partial area of the display module in which the second image is displayed, based on a user input,
transmit, to the external electronic device, the second image and information associated with the second object,
obtain, from the external electronic device, information associated with the second object changed by the external electronic device, and
display, through the display module, the second object based on the information changed by the external electronic device.

9. The electronic device of claim 8, wherein the instructions, when executed by the at least one processor individually or collectively, further cause the electronic device to:
transmit, to the external electronic device, a spatial movement request for the first object, based on a user input,
display the first object in at least a part of an area in which the second image is displayed, based on receiving a spatial movement response generated based on the spatial movement request from the external electronic device, and
transmit, to the external electronic device, spatial information of the second image and the changed information associated with the first object.

10. The electronic device of claim 9, wherein the instructions, when executed by the at least one processor individually or collectively, further cause the electronic device to:
transmit, to a server, a spatial movement request for the second object, based on obtaining the spatial movement request for the second object from the external electronic device,
transmit a spatial movement response for the second object to the external electronic device, based on receiving the spatial movement response generated based on the spatial movement request from the server,
obtain, from the external electronic device, information associated with the second object changed by the external electronic device, and
display the second object in at least a partial area of the display module in which the first image is displayed, based on the information changed by the external electronic device.

11. A method of controlling an object by an electronic device, the method comprising:
establishing, through a communication module, communication with an external electronic device;
displaying, through a display module, a first image and a first object, based on information obtained from the external electronic device;
changing information associated with the first object, based on a user input;
transmitting, to the external electronic device, the changed information associated with the first object;
obtaining, from the external electronic device, information associated with the first object changed by the external electronic device; and
displaying, through the display module, the first object, based on the information changed by the external electronic device.

12. The method of claim 11, wherein the information obtained from the external electronic device comprises spatial coordinates of the first image and the information associated with the first object.

13. The method of claim 12, wherein the information associated with the first object comprises:
a location of the first object in the spatial coordinates of the first image,
a rotation angle of the first object, and
attribute information of the first object.

14. The method of claim 13, wherein the changing of the information related to the first object comprises:
identifying the location of the first object in the spatial coordinates of the first image;
detecting an event for controlling the first object, based on a user input to an area corresponding to the location of the first object; and
based on detecting the event, changing the information associated with the first object.

15. The method of claim 11, further comprising:
identifying a movement for controlling the first object from an image obtained by a camera module; and
detecting an event for controlling the first object, based on the movement.

16. The method of claim 15, further comprising:
establishing, through the communication module, communication with a controller; and
detecting the event for controlling the first object, based on sensing information obtained from the controller.

17. The method of claim 16, further comprising:
detecting the event for controlling the first object, based on sensing information obtained by the display module.

18. The method of claim 11, further comprising:
displaying, through the display module, a second image obtained by a camera module;
displaying a second object in at least a partial area of the display module in which the second image is displayed, based on a user input;
transmitting, to the external electronic device, the second image and information associated with the second object;
obtaining, from the external electronic device, information associated with the second object changed by the external electronic device; and
displaying, through the display module, the second object based on the information changed by the external electronic device.

19. One or more non-transitory computer-readable storage media storing one or more computer programs including computer-executable instructions that, when executed by one or more processors of an electronic device individually or collectively, cause an electronic device to perform operations, the operations comprising:
establishing, through a communication module of the electronic device, communication with an external electronic device;
displaying, through a display module of the electronic device, a first image and a first object, based on information obtained from an external electronic device;
changing information associated with the first object, based on a user input,
transmitting, to the external electronic device, the changed information associated with the first object;
obtaining, from the external electronic device, information associated with the first object changed by the external electronic device; and
displaying, through the display module, the first object, based on the information changed by the external electronic device.

20. The one or more non-transitory computer-readable storage media of claim 19, the operations further comprising:
displaying, through the display module, a second image obtained by a camera module;
displaying a second object in at least a partial area of the display module in which the second image is displayed, based on a user input;
transmitting, to the external electronic device, the second image and information associated with the second object;
obtaining, from the external electronic device, information associated with the second object changed by the external electronic device; and
displaying, through the display module, the second object based on the information changed by the external electronic device.
